(19) United States
(12) Patent Application Publication
(10) Pub. No.: US 2007/0091238 A1
(43) Pub. Date: Apr. 26, 2007

(54) LIQUID CRYSTAL PANEL, PRINT MASK TO PRINT ALIGNMENT LAYER AND METHOD FOR MAKING THE ALIGNMENT LAYER

(76) Inventor: Ki Chul SHIN, Seongnam (KR)

Correspondence Address: MacPHERSON KWOK CHEN & HEID LLP, Suite 226, 1762 Technology Drive, San Jose, CA, 95110, US

(21) Appl. No.: 11/552,463

(22) Filed: Oct. 24, 2006

(30) Foreign Application Priority Data
Oct. 26, 2005 (KR) 10-2005-0101248

(51) Int. Cl. G02F 1/1337

(52) U.S. Cl. 349/124

(57) ABSTRACT

The present invention relates to a liquid crystal panel, a print mask to print an alignment layer and a method for making the alignment layer. According to embodiments of the present invention, a liquid crystal panel divided into an active area and a peripheral area comprises a first substrate; a second substrate opposing the first substrate; a liquid crystal arranged between the first substrate and the second substrate, a first alignment layer formed on the first substrate and having at least one first slit; and a seal pattern formed in the peripheral area on the first substrate to bind the first substrate with the second substrate, wherein the first slit is formed between the seal pattern and the active area. Embodiments also include a method for making the alignment layer. In another embodiment, a print mask for the alignment layer includes a base film; and a print pattern layer formed on the base film, the print pattern layer having at least one slit pattern formed in an edge region of the print pattern layer.

### CROSS REFERENCE TO RELATED APPLICATIONS

This application claims the benefit of priority of Korean Patent Application No. 10-2005-0101248 filed on Oct. 26, 2005, which is hereby incorporated by reference in its entirety.

### BACKGROUND OF THE INVENTION

1. Field of the Invention

The present invention relates to a liquid crystal panel, a print mask to print the alignment layer and a method for making the alignment layer. More particularly, some embodiments of the present invention relate to liquid crystal panel to substantially prevent uncured components of a seal pattern from being diffused into the alignment layer of the liquid crystal panel, a print mask to print the alignment layer and a method for making the alignment layer.

2. Description of the Related Art

In general, liquid crystal displays (LCDs) are used in a wide variety of applications, because they are lightweight, thin, consume little power, and have full color and high resolution characteristics. In order to display a desired image on an LCD panel, a liquid crystal material is used to adjust an amount of light transmitted in accordance with image signals applied to a number of control switches arrayed in a matrix configuration. Since the LCD cannot emit light by itself, it requires a light source, such as a backlight unit.

A process for forming a liquid crystal panel will be briefly discussed. First, a process of applying and rubbing an alignment film is performed. The alignment film aligns liquid crystal molecules in a predetermined direction on the surfaces of an upper substrate and lower substrate, i.e. a color filter substrate and a thin film transistor substrate and a thin film transistor substrate, respectively.

Next, a seal pattern is formed on the thin film transistor substrate to seal injected or dropped liquid crystal material. A process of forming a short connecting a common electrode terminal of the color filer substrate to a bonding pad of the thin film transistor substrate is performed. Then, a spacer for maintaining a cell gap is scattered on the color filter substrate. Thereafter, the two substrates are aligned and bonded together, and liquid crystal material is provided to the liquid crystal panel using a liquid crystal vacuum filling or drop filling process, completing the manufacturing process.

At this time, if the seal pattern is brought into contact with the liquid crystal before the material of the seal pattern is cured, uncured sealant components are directly diffused into the liquid crystal or adsorbed on the alignment layer. FIG. 1 shows a conceptual diagram illustrating a state where uncured sealant components of the seal pattern are diffused into an active area. As a result, there is a problem in that pixel defects are caused due to diffused uncured sealant components.

### SUMMARY OF THE INVENTION

Exemplary embodiments according to the present invention solve or mitigate the aforementioned problems in the prior art. Accordingly, an embodiment of the present invention comprises a first substrate; a second substrate opposing the first substrate; a liquid crystal arranged between the first substrate and the second substrate, a first alignment layer formed on the first substrate and having at least one first slit; and a seal pattern formed in the peripheral area on the first substrate to bind the first substrate with the second substrate, wherein the first slit is formed between the seal pattern and the active area.

At least a portion of the seal pattern is formed on the first alignment layer.

The first slit is formed only in the peripheral area in which the seal pattern is formed on the first alignment layer.

The second substrate comprises a black matrix and the black matrix is formed on the peripheral area.

The liquid crystal panel further comprises a second alignment layer having at least one second slit and formed on the second substrate, and wherein at least a portion of the seal pattern disposed on the second alignment layer, and the second slit is formed between the seal pattern and the active area.

The first and second slits are formed in a direction in which the seal pattern is extended.

The first and second slits have a width of about 1 to 5 mm.

The liquid crystal panel further comprises a driving circuit to drive a signal line formed on the first substrate or the second substrate, wherein the driving circuit is formed in the peripheral area on the first substrate or the second substrate in which the signal line is formed.

The second substrate comprises a black matrix on the peripheral area and the black matrix covers the first slit.

According to an aspect of the present invention, a liquid crystal panel divided into an active area and a peripheral area comprises a first substrate; a second substrate opposing the first substrate; a liquid crystal arranged between the first substrate and the second substrate, a first alignment layer formed on the first substrate and having at least one first slit; and a seal pattern formed in the peripheral area on the first substrate to bind the first substrate with the second substrate, at least a portion of the seal pattern formed on the first alignment layer, wherein the first slit is formed between the seal pattern and the active area.

According to another aspect of the present invention, a method for making an alignment layer to be included in a liquid crystal panel, comprises (a) providing a print mask to print the alignment layer on a substrate to be included in the liquid crystal display panel, the print mask including at least one slit pattern formed in an edge region thereof; (b) applying alignment liquid onto the print mask; (c) bringing the print mask with the alignment liquid applied thereon into contact with the substrate; and (d) forming the alignment layer by printing the alignment liquid on the substrate.

According to further aspect of the present invention, a print mask to print alignment layer on the substrate of a liquid crystal panel comprises a base film; and a print pattern layer formed on the base film, the print pattern layer having at least one slit pattern formed in an edge region of the print pattern layer.

### BRIEF DESCRIPTION OF THE DRAWINGS

The above and other features and advantages of the present invention will become apparent from the following description of exemplary embodiments given in conjunction with the accompanying drawings, in which:

FIG. 1 is a conceptual diagram illustrating a state where uncured components of a to seal pattern are diffused into an active area in liquid crystal panel of the prior art;

FIG. 2 is a sectional view of a liquid crystal panel of the present invention;

FIGS. 3A and 3B are plan and sectional views schematically illustrating an alignment layer structure formed on a substrate in an LCD according to an embodiment of the present invention;

FIG. 4 is a photograph showing a portion corresponding to an “A” region of FIG. 3a;

FIG. 5 is a schematic view showing a general alignment layer printing device;

FIGS. 6A and 6B are plan views of print masks for the alignment layer according to an embodiment of the present invention;

FIGS. 7A and 7B are sectional views of the print masks for the alignment layer according to embodiments of the present invention;

FIG. 8 is a schematic sectional view of the alignment layer formed on a substrate using the print mask for the alignment layer according to an embodiment of the present invention; and

FIG. 9 is a flowchart illustrating a method for making the alignment layer according to an embodiment of the present invention.

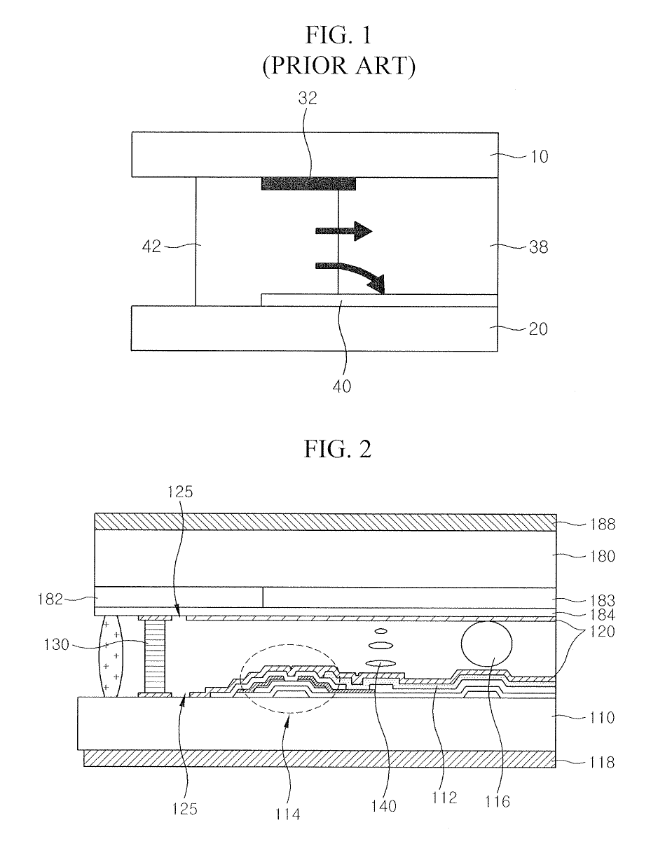

### DETAILED DESCRIPTION OF THE INVENTION

The invention is described more fully hereinafter with reference to the accompanying drawings, in which exemplary embodiments of the present invention are shown. This invention may, however, be embodied in many different forms and should not be construed as limited to the exemplary embodiments set forth herein. Rather, these exemplary embodiments are provided so that this disclosure will be thorough and complete, and will fully convey the scope of the present invention to those skilled in the art. In the drawings, the size and relative sizes of layers and regions may be exaggerated for clarity.

It will be understood that when an element or layer is referred to as being “on”, “connected to” or “coupled to” another element or layer, it can be directly on, connected to or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular exemplary embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the present invention are described herein with reference to cross-section illustrations that are schematic illustrations of idealized exemplary embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments of the present invention will be described in detail with reference to the accompanying drawings.

FIG. 2 is a sectional view of a liquid crystal panel of the present invention. Referring to FIG. 2, a black matrix 182, a color filter 183 and a common electrode 184 are sequentially formed on a bottom surface of an upper substrate 180, and a polarizer 188 is formed on a top surface of the upper substrate 180. The black matrix 182, which has been formed between the color filter 183 and a pixel, shields leaking light. The color filter 183 is made of a resin film containing dyes or pigments of three basic colors (such as red, green and blue). Further, the common electrode 184 is an electrode made of a transparent electrical conductor such as ITO, and is used to apply a voltage to liquid crystal cells.

A thin film transistor 114, pixel electrode 112, and a storage capacitor (not shown) are formed on a top surface of a lower substrate 110. Thin film transistor 114 serves as a switch element to apply or cut off a signal voltage to the liquid crystal. Pixel electrode 112 comprises a transparent and electrically conductive material such as ITO and/or IZO and functions to supply the signal voltage applied from the thin film transistor 114 to the liquid crystal cells. The storage capacitor is configured to sustain the signal voltage applied to the pixel electrode 112 for a certain period of time. Further, a polarizer 118 is formed on a bottom surface of the lower substrate 110.

Alignment layers 140 comprising thin organic polymide film are formed on the lowermost layer of the upper substrate 180 and the uppermost layer of the lower substrate 110. Slits 125, each of which has a predetermined width, are formed in the alignment layer 120. A spacer 116 for securing a space between the upper substrate 180 and lower substrate 110 is disposed between the upper and the lower substrates, and liquid crystal layers 140 are injected into the space provided by the spacer 116 between the substrates. A seal pattern 130 is formed at peripheral portions of the liquid crystal panel to fix the upper and lower substrates 180 and 110.

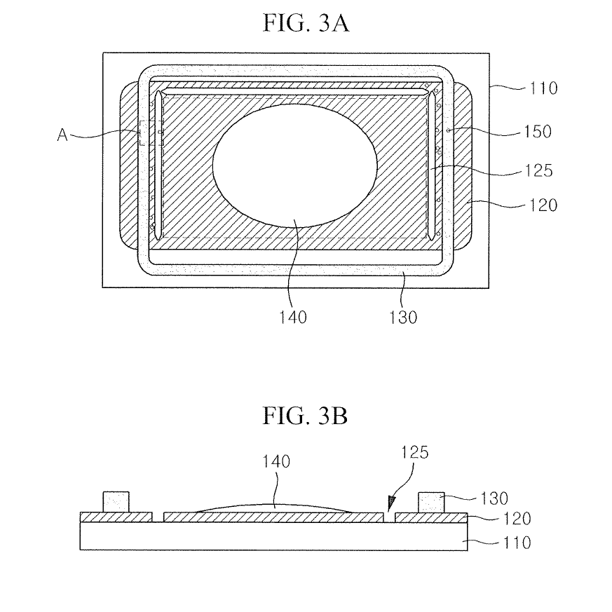

FIGS. 3A and 3B are plan and sectional views schematically illustrating an alignment layer structure formed on a substrate in a liquid crystal display (LCD) according to an embodiment of the present invention.

The alignment layer structure will be described with reference to FIGS. 3A and 3B. An alignment layer 120 to align liquid crystal molecules in a predetermined direction is formed on a substrate 110 of an LCD. The alignment layer 120 is formed on an active area I (designated by dotted lines in FIG. 3A) corresponding to a display region of a liquid crystal panel, and formed on peripheral area II (i.e., area except the active area of the substrate) of the liquid crystal panel.

A seal pattern 130 serving as an adhesive to fix upper and lower substrates of the LCD to one another is positioned at the peripheral portions of the substrates. In this embodiment, as viewed from FIG. 3A, left and right portions of the seal pattern 130 are positioned on the alignment layer 120, and an upper portion of the seal pattern 130 is positioned such that a part of the upper portion of the seal pattern is brought into contact with the alignment layer 120. Further, a lower portion of the seal pattern 130 is separated by a predetermined interval from the alignment layer 120.

Three slits 125, each of which has a predetermined width, are formed in the alignment layer 120 around the active area. The slits 125 are formed between the active area and the left portion of the seal pattern 130, between the active area and the upper portion of the seal pattern 130, and between the active area and the right portion of the seal pattern 130, respectively, to prevent uncured sealant components 150 of the seal pattern 130 from being diffused into the alignment layer 120 and liquid crystal in the active area.

The slits 125 are formed in the alignment layer 120 between the active area and the seal pattern for instances where the seal pattern 130 is positioned on the alignment layer 120 or positioned to be brought into contact with the alignment layer 120. The reason is that uncured sealant components of a seal pattern can be more easily diffused into liquid crystal or an alignment layer when the seal pattern and alignment layer are brought into contact with each other than when they are separated from one another, because both the sealant material of the seal pattern and the alignment layer material contain organic substances.

However, even in a configuration where a seal pattern is neither positioned on an alignment layer nor positioned to be brought into contact with the alignment layer (that is, different than the configuration illustrated in FIG. 3A), a slit may be formed on a portion of the alignment layer adjacent to the seal pattern.

Additionally, the slits 125 may be formed in the same direction as a direction in which the seal pattern 130 is formed, and that the width of the slit 125 be 1 to 5 mm. However, the width of the slit and the distance between the seal pattern and the slit can be changed according to the size of the liquid crystal panel, the process margin or the like. Further, the plurality of slits can be connected to one another and then formed into a single slit.

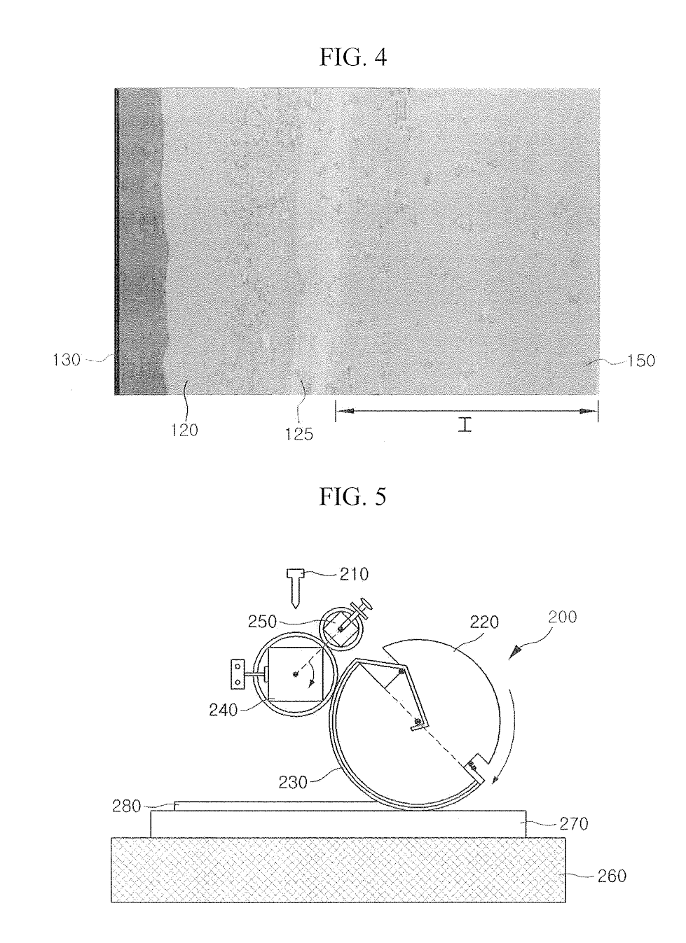

FIG. 4 is a photograph showing a portion corresponding to an “A” region of FIG. 3A. Referring to FIG. 4, in the alignment layer structure according to embodiments of the present invention wherein the slits 125 having a predetermined width are formed in the alignment layer 120 around the active area as shown in FIGS. 3A and 3B, most of the diffusing uncured sealant components 150 of the seal pattern 130 are diffused only to the alignment layer outside the slits 125. That is, only portions of the uncured sealant components are diffused into the slits 125 and the active area I. Accordingly, it can be understood from FIG. 4 that relatively small amounts of the uncured sealant components are diffused into the liquid crystal and the alignment layer in the active area.

FIG. 5 is a schematic view illustrating a alignment layer printing device.

Referring to FIG. 5, the alignment layer printing device comprises a dispenser 210, a printing roll 220, a print mask 230 for alignment layer 280, an anilox roll 240, a doctor roll 250 and a stage 260. In FIG. 5, a substrate 270 is seated on the stage 260, and an alignment layer 280 is printed on the substrate 270 using the alignment layer printing device 200.

The dispenser 210 supplies an alignment liquid (not shown), and the printing roll 220 prints the alignment liquid on the substrate 270 using the print mask 230 configured to hold the alignment liquid for the alignment layer 280 which is attached onto a surface of the printing roll 220. The anilox roll 240 applies alignment liquid onto the print mask 230, and the doctor roll 250 covers the anilox roll 240 substantially uniformly with alignment liquid supplied by the dispenser 210.

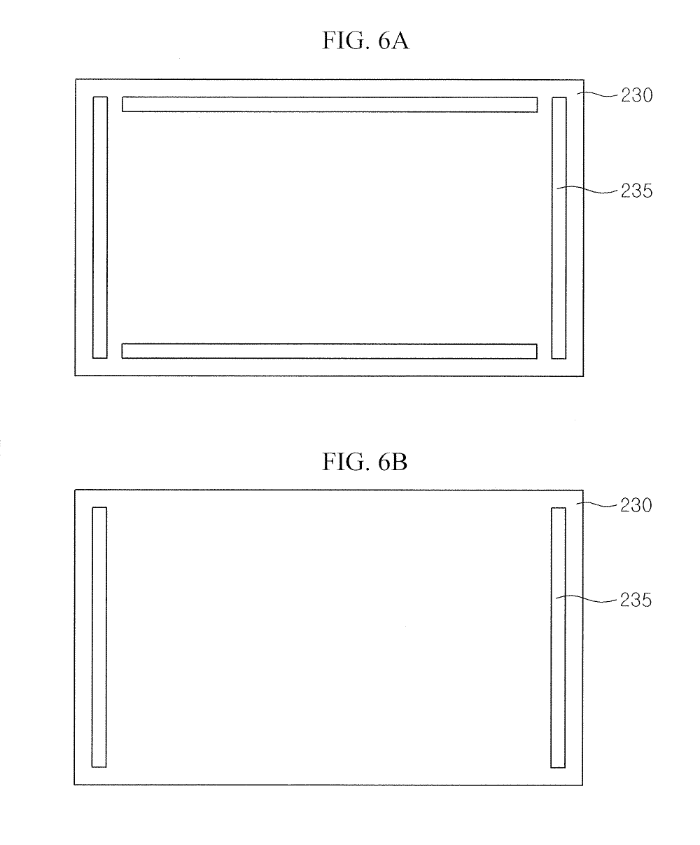

FIGS. 6A and 6B are plan views of print masks 230 for use in the alignment layer according to the exemplary embodiment of the present invention. Print masks 230 may comprise patterned print mask material having a first region shaped and positioned to print the alignment material on an associated active region of the substrate, and an edge region adjacent the first region shaped and configured to print the alignment material on an associated region of the substrate outside the active region.

As shown in FIG. 6A, four slits 235, each of which has a predetermined width, are formed on edge regions of the print mask 230 for the alignment layer. The number of slits is not limited thereto. In another example, only two slits 235 may be formed on the left and right edge regions, respectively, as shown in FIG. 6B.

As described above, the number of slits and their positions on the print mask 230 can be changed. The positions of the slits formed on the print mask can be changed depending on the relative configuration of the seal pattern and the alignment layer; for example, dependent on positions where the seal pattern is formed on the alignment layer or brought into contact with the alignment layer.

Further, the width of the slit(s) is within a range of 1 to 5 mm but can be changed according to the size of the liquid crystal panel, the process margin or the like. Further, the plurality of slits can be connected to one another and then formed into a single slit. The slit width need not be uniform.

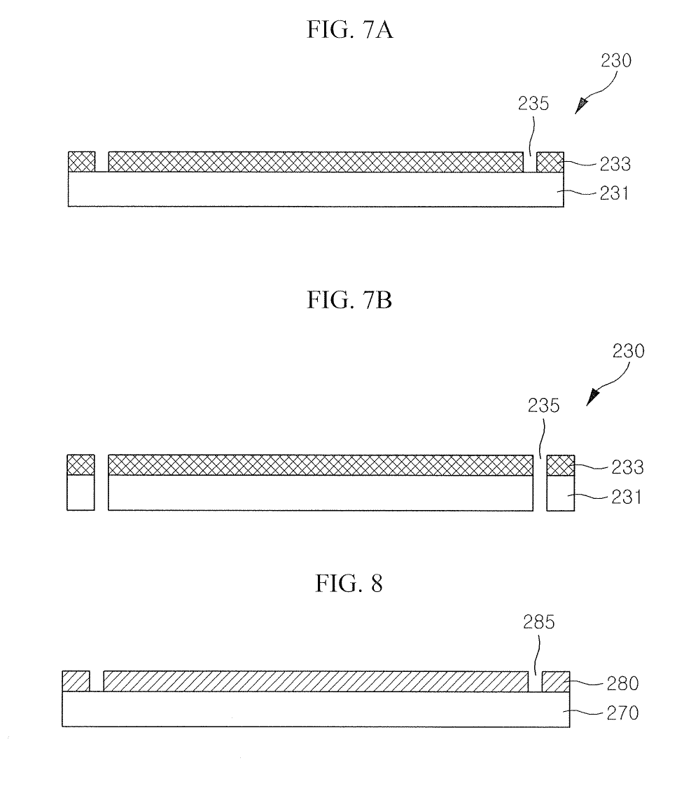

FIGS. 7A and 7B are sectional views of print masks for use in forming the alignment layer according to the exemplary embodiments of the present invention. Referring to FIG. 7A, the print mask 230 includes a base film 231 to be attached onto the surface of the printing roll 220 (see FIG. 5), and a print pattern layer 233 formed on the base film 231 to hold the alignment liquid therein. The print mask 230 for use in the alignment layer may be made of a polymeric resin. In particular, the print pattern layer 233 may be made of a resin having excellent adhesive strength, e.g. a polybutene resin, to hold an alignment liquid therein. A mixed solution of polyimide may be used as the alignment liquid.

Slits 235, each of which has a predetermined width, are formed on the edge regions of the print pattern layer 233. In the embodiment of FIG. 7B, the slits extend through base film 231, while in the embodiment of FIG. 7A, the slits 235 extend up to the base film 231.

If the alignment layer 280 (see FIG.5) is printed on the substrate 270 (see FIG. 5) using the print mask 230 as configured in FIGS. 7A and 7B, the alignment liquid is applied onto the print pattern layer 233 of the print mask 230. Thus, an alignment layer in which slits with substantially the same size and shape as those of the slits 235 are formed can also be printed on the substrate.

FIG. 8 Shows a schematic sectional view of an alignment layer 280 having slits 285 formed on the substrate 270 using the print mask 230 (see FIGS. 7A and 7B) for the alignment layer 280 according to the exemplary embodiments of the present invention.

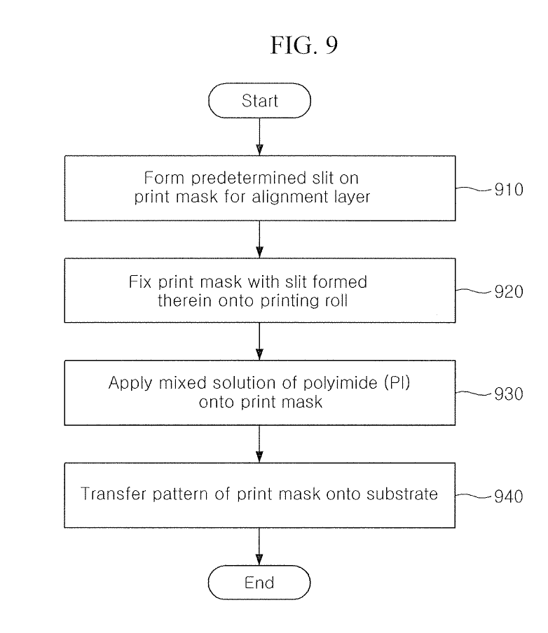

FIG. 9 is a flowchart illustrating a method for making an alignment layer according to the present invention.

A process of forming the alignment layer according to an exemplary embodiment of the present invention will be explained with reference to FIG. 9. First, one or more slits each having a predetermined shape are formed on the print mask for the alignment layer (at 910). At this time, at least one slit having a predetermined width is formed on the edge region of the print mask. Since the characteristics of the print mask are the same as described above, the description thereof will be omitted herein.

Next, the print mask with the slits formed therein is fixed on a printing roll in an alignment layer printing device (at 920).

Subsequently, an alignment liquid is applied to the print mask (at 930). In this embodiment, a mixed solution of polyimide is used as the alignment liquid. The alignment liquid is supplied using a dispenser of the alignment layer printing device and applied to the print mask fixed on the printing roll through the other rotating rolls.

Finally, the alignment layer is printed on the substrate by transferring the pattern of the print mask with the alignment liquid applied thereon to the substrate (at 940). If the substrate mounted on the moving stage is moved at the same speed as the printing roll in a state where the substrate is aligned with and brought into contact with the printing roll with the print mask fixed thereon, the pattern of the print mask with the alignment layer material applied thereon is transferred to the alignment layer formed on the substrate. As a result, the slits formed on the print mask are also formed on the alignment layer formed on the substrate.

As described above, according to the exemplary embodiments of the present invention, since the slits each of which has a predetermined width are formed on the edge regions of the alignment layer, most of uncured sealant components of the seal pattern are diffused only to the portion of the alignment layer positioned outside the slits. Therefore, the systems and techniques provided herein have the advantage in that the uncured sealant components are substantially prevented from being diffused into the liquid crystal and the alignment layer in the active area, thereby substantially preventing the associated pixel defects.

The foregoing is merely an exemplary embodiment of an alignment layer of a liquid crystal display, a print mask for the alignment layer, and a method for making the alignment layer according to the present invention. Thus, the present invention is not limited thereto. Although the present invention has been described in detail in connection with the preferred embodiment, it will be readily understood by those skilled in the art that various modifications and changes can be made thereto within the technical spirit and scope of the present invention. It is also apparent that the modifications and changes fall within the scope of the present invention defined by the appended claims.

What is claimed is:

1. A liquid crystal panel divided into an active area and a peripheral area, comprising:
a first substrate;
a second substrate opposing the first substrate;
a liquid crystal arranged between the first substrate and the second substrate,
a first alignment layer formed on the first substrate and having at least one first slit; and
a seal pattern formed in the peripheral area on the first substrate to bind the first substrate with the second substrate,
wherein the first slit is formed between the seal pattern and the active area.

2. The liquid crystal panel as claimed in claim 1, wherein at least a portion of the seal pattern is formed on the first alignment layer.

3. The liquid crystal panel as claimed in claim 2, wherein the first slit is formed only in the peripheral area in which the seal pattern is formed on the first alignment layer.

4. The liquid crystal panel as claimed in claim 2, further comprising a second alignment layer having at least one second slit and formed on the second substrate, and wherein at least a portion of the seal pattern disposed on the second alignment layer, and the second slit is formed between the seal pattern and the active area.

5. The liquid crystal panel as claimed in claim 4, wherein the first and second slits are formed in a direction in which the seal pattern is extended.

6. The liquid crystal panel as claimed in claim 4, wherein the first and second slits have a width of about 1 to 5 mm.

7. The liquid crystal panel as claimed in claim 4, further comprising a driving circuit to drive a signal line formed on the first substrate or the second substrate, wherein the driving circuit is formed in the peripheral area on the first substrate or the second substrate in which the signal line is formed.

8. The liquid crystal panel as claimed in claim 3, wherein the second substrate comprises a black matrix on the peripheral area and the black matrix covers the first slit.

9. A liquid crystal panel divided into an active area and a peripheral area, comprising:
a first substrate;
a second substrate opposing the first substrate;
a liquid crystal arranged between the first substrate and the second substrate,
a first alignment layer formed on the first substrate and having at least one first slit; and
a seal pattern formed in the peripheral area on the first substrate to bind the first substrate with the second substrate, at least a portion of the seal pattern formed on the first alignment layer,
wherein the first slit is formed between the seal pattern and the active area.

10. The liquid crystal panel as claimed in claim 9, wherein the first slit is formed only in the peripheral area in which the seal pattern is formed on the first alignment layer.

11. The liquid crystal panel as claimed in claim 10, further comprising a second alignment layer having at least one second slit and formed on the second substrate, and wherein at least a portion of the seal pattern disposed on the second alignment layer, and the second slit is formed between the seal pattern and the active area.

12. The liquid crystal panel as claimed in claim 11, wherein the second slit is formed only in the peripheral area in which the seal pattern is disposed on the second alignment layer.

13. The liquid crystal panel as claimed in claim 9, wherein the first slit is formed in a direction in which the seal pattern is extended.

14. The liquid crystal panel as claimed in claim 9, wherein the first slit has a width of about 1 to 5 mm.

15. The liquid crystal panel as claimed in claim 9, further comprising a driving circuit to drive a signal line formed on the first substrate, wherein the driving circuit is formed in the peripheral area on the first substrate.

16. The liquid crystal panel as claimed in claim 10, wherein the second substrate comprises a black matrix on the peripheral area and the black matrix covers the first slit.

17. A method for making an alignment layer to be included in a liquid crystal panel, comprising:
(a) providing a print mask to print the alignment layer on a substrate to be included in the liquid crystal display panel, the print mask including at least one slit pattern formed in an edge region thereof;
(b) applying alignment liquid onto the print mask;
(c) bringing the print mask with the alignment liquid applied thereon into contact with the substrate; and
(d) forming the alignment layer by printing the alignment liquid on the substrate.

18. The method as claimed in claim 17, wherein the print mask comprises:
a base film; and
a print pattern layer formed on the base film, the print pattern layer configured to hold an alignment liquid therein.

19. The method as claimed in claim 18, wherein the print pattern layer has the slit pattern to expose the base film.

20. The method as claimed in claim 17, wherein the at least one slit pattern has a width of about 1 to 5 mm.

21. The method as claimed in claim 17, wherein the print mask comprises a polymeric resin.

22. A print mask to print alignment layer on the substrate of a liquid crystal panel, comprising:
a base film; and
a print pattern layer formed on the base film, the print pattern layer having at least one slit pattern formed in an edge region of the print pattern layer.
